(19) United States
(12) Patent Application Publication
(10) Pub. No.: US 2026/0154663 A1
(43) Pub. Date: Jun. 4, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Daekee KIM, Suwon-si (KR); Sangjin KIM, Suwon-si (KR); Sungjong KIM, Suwon-si (KR); Gyusung NA, Suwon-si (KR); Nokhaeng LEE, Suwon-si (KR); Sung HAN, Suwon-si (KR); Kwanwoo HONG, Suwon-si (KR)

(73) Assignee: SAMSUNG ELECTRONICS CO., LTD., Suwon-si (KR)

(21) Appl. No.: 19/385,785

(22) Filed: Nov. 11, 2025

Related U.S. Application Data
(63) Continuation of application No. PCT/KR2025/014107, filed on Sep. 10, 2025.

(30) Foreign Application Priority Data
Nov. 29, 2024 (KR) 10-2024-0174695

(51) Int. Cl. G06Q 10/20; H04L 67/306

(52) U.S. Cl. CPC G06Q 10/20; H04L 67/306

(57) ABSTRACT

An electronic apparatus includes: communication circuitry configured to perform communication with an external device; memory storing at least one instruction and service history information; and at least one processor operatively coupled to the memory and the communication circuitry, in which the at least one instruction, when executed by the at least one processor individually or collectively, cause the electronic apparatus to: based on service request information being received from the external device, identify at least one user tendency based on the received service request information; search a processing history corresponding to the identified at least one user tendency using the service history information; and generate service information based on the processing history.

### CROSS-REFERENCE TO RELATED APPLICATIONS

This application is a continuation application, under 35 U.S.C. § 111(a), of international application No. PCT/KR2025/014107, filed on Sep. 10, 2025, which claims priority under 35 U.S.C. § 119 to Korean Patent Application No. 10-2024-0174695, filed on Nov. 29, 2024, the disclosures of which are incorporated herein by reference in their entireties.

### BACKGROUND

### 1. Field

The present disclosure relates to an electronic apparatus capable of identifying a user tendency based on a user request phrase and providing a customized service based on the identified user tendency and a controlling method thereof.

### 2. Description of Related Art

An electronic apparatus can perform various functions (or operations) by utilizing various internal components. The electronic apparatus may experience errors (e.g., defects) due to aging or failure of the internal components.

When such errors occur, a user may request the manufacturer to repair the electronic apparatus, etc., and the manufacturer can provide a service in response to the user's request.

### SUMMARY

Embodiments of the present disclosure may solve at least one of the problems and/or disadvantages described above and provide the advantages described below. Accordingly, the embodiments of the present disclosure provide an electronic apparatus capable of identifying a user tendency based on a user request phrase and providing a customized service based on the identified user tendency.

Additional embodiments will be described in detail hereinafter: some will be apparent from the detailed description and others may also be derived from the described embodiments through knowledge gained therefrom.

According to an aspect of the disclosure, an electronic apparatus includes: communication circuitry configured to perform communication with an external device; memory storing at least one instruction and service history information; and at least one processor operatively coupled to the memory and the communication circuitry, wherein the at least one instruction, when executed by the at least one processor individually or collectively, cause the electronic apparatus to: based on service request information being received from the external device, identify at least one user tendency based on the received service request information; search a processing history corresponding to the identified at least one user tendency using the service history information; and generate service information based on the processing history.

The service history information includes tendency information, guide information, and evaluation information corresponding to each of a plurality of service processing cases; and in which the at least one instruction, when executed by the at least one processor individually or collectively, cause the electronic apparatus to: perform a first search based on the identified at least one user tendency and tendency information of the service history information; and perform a second search based on evaluation information among a result of the first search.

The identified at least one user tendency has grade information for each of a plurality of items; and in which the at least one instruction, when executed by the at least one processor individually or collectively, further cause the electronic apparatus to further perform the first search based on the grade information for each of the plurality of items.

The service request information includes information of a home appliance and error information; and in which the at least one instruction, when executed by the at least one processor individually or collectively, further cause the electronic apparatus to perform the first search within service history information corresponding to the information of the home appliance and the error information.

The service request information includes sound source information recorded from a noise generated by a home appliance; and in which the at least one instruction, when executed by the at least one processor individually or collectively, further cause the electronic apparatus to control the communication circuitry to provide the generated service information and the sound source information to an external device corresponding to a repair technician.

The at least one instruction, when executed by the at least one processor individually or collectively, further cause the electronic apparatus to control the communication circuitry to transmit estimated processing schedule information corresponding to the generated service information to the external device.

The at least one instruction, when executed by the at least one processor individually or collectively, further cause the electronic apparatus to identify a user tendency by checking at least one of a negative tendency, a repetition tendency, an unresolved status based on text in the received service request information.

The at least one instruction, when executed by the at least one processor individually or collectively, further cause the electronic apparatus to determine one negative grade among a plurality of negative grades based on a type and number of predefined negative keywords among keywords included in the text.

The at least one instruction, when executed by the at least one processor individually or collectively, further cause the electronic apparatus to determine one repetition grade among a plurality of repetition grades based on a number of repetitions of a service request received from the external device.

The at least one instruction, when executed by the at least one processor individually or collectively, further cause the electronic apparatus to determine one unresolved grade among a plurality of unresolved grades based on a service request history received from the external device and the text.

According to an aspect of the disclosure, a controlling method of an electronic apparatus, the method including receiving service request information from an external device; identifying at least one user tendency based on the received service request information; searching a processing history corresponding to the identified at least one user tendency using pre-stored service history information; and generating service information based on the processing history.

The service history information includes tendency information, guide information and evaluation information corresponding to each of a plurality of service processing cases; and the searching includes: performing a first search based on the identified at least one user tendency and tendency information of the service history information; and performing a second search based on evaluation information among a result of the first search.

The identified at least one user tendency has grade information for each of a plurality of items; and the searching further includes performing the first search based on the grade information for each of the plurality of items.

The service request information includes information of a home appliance and error information; and the searching further comprises performing the first search within service history information corresponding to the information of the home appliance and the error information.

According to an aspect of the disclosure, a non-transitory computer-readable recording medium having instructions stored therein, which when executed by a processor of an electronic apparatus, cause the processor execute a controlling method including: receiving service request information from an external device; identifying at least one user tendency based on the received service request information; searching a processing history corresponding to the identified at least one user tendency using pre-stored service history information; and generating service information based on the processing history.

### BRIEF DESCRIPTION OF DRAWINGS

Other aspects, features, and advantages of the embodiments according to the present disclosure will become more apparent from the following description with reference to the accompanying drawings:

FIG. 1 is a view provided to explain an electronic system according to one or more embodiments;

FIG. 2 is a view provided to explain a method of providing a customized service according to an embodiment;

FIG. 3 is a view provided to explain configuration of an electronic apparatus according to an embodiment;

FIG. 4 is a view provided to explain configuration of a terminal device according to an embodiment;

FIG. 5 is a view provided to explain a service processing operation according to an embodiment;

FIG. 6 is a view provided to explain an operation of obtaining a user tendency according to an embodiment;

FIG. 7 is a view provided to explain an operation of searching a processing history according to an embodiment;

FIG. 8 is a view illustrating an example of searching a processing history according to an embodiment;

FIG. 9 is a view illustrating an example of searching a processing history according to an embodiment;

FIG. 10 is a view illustrating an example of searching a processing history according to an embodiment;

FIG. 11 is a flowchart provided to explain a controlling method of an electronic apparatus according to an embodiment; and

FIG. 12 is a flowchart provided to explain a controlling method of a terminal device according to an embodiment.

### DETAILED DESCRIPTION

For a comprehensive understanding of the various embodiments defined by the claims and their equivalents, a detailed description will be provided with reference to the accompanying drawings. Although various embodiments are included herein to aid understanding, these are merely illustrative. Therefore, modifications and alterations made by a person of ordinary skill in the art, based on the disclosure herein, should be understood to fall within the scope of the present disclosure. Furthermore, well-known functions and components may be omitted for clarity and conciseness.

The terms and words used in the detailed description or the claims are not meant to be limited to their literal or dictionary meanings but are used by the inventor to facilitate understanding of the disclosure. Therefore, it is clear that the following description of various embodiments is illustrative in nature and is not intended to limit the definition of the appended claims and their equivalents.

In the present disclosure, singular forms such as “a,” “an,” and “the” should be understood to encompass the plural as well, unless the context expressly indicates otherwise. For example, “a component surface” should be interpreted to include one or more such components.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope of the technical spirit of the disclosure is not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

In the disclosure, an expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In the disclosure, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Meanwhile, various elements and regions in the drawings are schematically drawn in the drawings. Therefore, the technical concept of the disclosure is not limited by a relative size or spacing drawn in the accompanying drawings.

Hereinafter, one or more embodiments according to the present disclosure will be described in detail with reference to the accompanying drawings so that a person with ordinary knowledge in the technical field to which the present disclosure belongs can easily implement the present disclosure.

The blocks and combinations of flowcharts within each flowchart can be performed by one or more computer programs including instructions. The one or more computer programs may be stored entirely in a single memory device, or the one or more computer programs may be divided into several parts and stored in different memory devices.

Any of the functions and operations described herein may be processed by a single processor or a combination of processors. A single processor or a combination of processors may include a circuit that performs processing, an application processor (e.g., a central processing unit (CPU), a communication processor (e.g., a modem), a graphics processing unit (GPU), a neural processing unit (NPU) (e.g., an AI chip), a Wi-Fi, chip, a Bluetooth chip, a GPS chip, an NFC chip, a connectivity chip, a sensor controller, a touch controller, a fingerprint sensor controller, a display driver integrated circuit, an audio CODEC chip, a universal serial bus (USB) controller, a camera controller, an image processing IC, a microprocessor unit (MPU), a system on chip (SoC), an integrated circuit (IC), etc.).

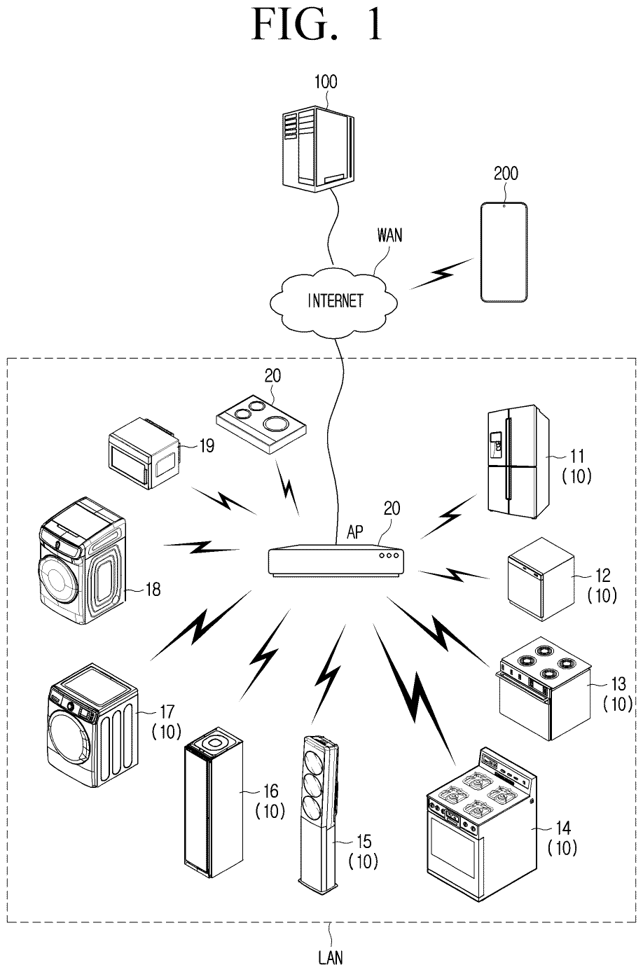

FIG. 1 is a view provided to explain an electronic system according to an embodiment.

A home appliance 10 may include a communication module (e.g., communication circuitry) configured to perform communication with another home appliance, a user device 200, or an electronic apparatus 100, a user interface for receiving a user input or outputting information to a user, at least one processor for controlling the operation of the home appliance 10, and at least one memory storing a program for controlling the operation of the home appliance 10.

The home appliance 10 may include various types of home appliances as illustrated in FIG. 1 (e.g., the home appliance 10 may include at least one of a refrigerator 11, a dishwasher 12, a gas range 13, an electric oven 14, an air conditioner 15, a clothes manager 16, a washing machine 17, a dryer 18, a microwave oven 19, or a cooking appliance 20). In one or more examples, the cooking device 20 may include a gas range, an electric oven, a microwave oven, an induction, a highlight, or any other suitable appliance known to one of ordinary skill in the art. In one or more examples, the appliance of the electronic system may be a non-home appliance such as an appliance located in a vehicle.

In addition to the examples described above, the home appliance 10 may include various types of home appliances such as a cleaning robot, a vacuum cleaner, a television, and the like.

In addition, the home appliances mentioned above are only examples, and in addition to the home appliances mentioned above, devices that are connected to other home appliances, the user device 200 or the electronic apparatus 100 and can perform the operations described below may be included in the home appliance 10 according to an embodiment.

The electronic apparatus 100 may include a communication module capable of performing communication with another server, the home appliance 10, or the user device 200, at least one processor capable of processing data received from another server, the home appliance 10, or the user device 200, and at least one memory capable of storing a program for processing data or processed data.

Such an electronic apparatus 100 may be implemented as various computing devices such as a server, a workstation, a cloud, a data drive, a data station, and the like. The electronic apparatus 100 may be implemented as one or more servers physically or logically separated based on functions, detailed configurations of functions, or data, etc., and may transmit and receive data and process the transmitted and received data through communication between each server.

The electronic apparatus 100 may perform functions such as managing a user account, registering the home appliance 10 under a user account, and managing or controlling the registered home appliance 10. For example, a user may access the electronic apparatus 100 through the user device 200 and create a user account. The user account may be identified by an ID and password set by the user.

The electronic apparatus 100 may register the home appliance 10 to a user account according to a set procedure. For example, the electronic apparatus 100 may register, manage, and control the home appliance 10 by linking the identification information (e.g., serial number or MAC address) of the home appliance (10) to the user account.

The user device 200 may include a communication module capable of performing communication with the home appliance 10 or the electronic apparatus 100, a user interface for receiving a user input or outputting information to a user, at least one processor for controlling the operation of the user device 200, and at least one memory storing a program for controlling the operation of the user device 200.

The user device 200 may be carried by the user or placed in the user's home or office, etc. The user device 200 may include, but is not limited to, a personal computer, a terminal, a portable telephone, a smart phone, a handheld device, a wearable device, etc. Such a user device may be referred to as a terminal device, a terminal device, etc.

The program for controlling the home appliance 10, e.g., an application, may be stored in the memory of the user device 200. The application may be sold with the user device 200 already installed, or may be downloaded and installed from an external server.

The user may access the electronic apparatus 100 by executing the application installed on the user device 200, create a user account, and perform communication with the electronic apparatus 100 based on the logged-in user account to register the home appliance 10.

For example, when the home appliance 10 is operated so that the home appliance 10 can be connected to the electronic apparatus 100 according to the procedure guided by the application installed on the user device 200, the home appliance 10 can be registered to the user account by registering identification information (e.g., serial number or MAC address) of the home appliance 10 to the corresponding user account in the electronic apparatus 100.

The user may control the home appliance 10 using an application installed in the user device 200. For example, when the user logs into a user account using an application installed in the user device 200, the home appliance 10 registered to the user account appears, and when a control command for the home appliance 10 is input, the control command may be transmitted to the home appliance 10 through the electronic apparatus 100.

Networks can include both wired and wireless networks. Wired networks include cable networks or telephone networks, and wireless networks can include any network that sends and receives signals over radio waves. Wired and wireless networks can be connected to each other.

Networks can include wide area networks (WANs) such as the Internet, local area networks (LANs) formed around access points (APs), and short-range wireless networks that do not go through access points (APs). A short-range wireless network may include, but is not limited to, Bluetooth (Bluetooth™, IEEE 802.15.1), Zigbee (IEEE 802.15.4), Wi-Fi Direct, Near Field Communication (NFC), Z-Wave, and the like.

An access point (AP) 30 may connect the home appliance 10 or the user device 200 to a wide area network (WAN) to which the electronic apparatus 100 is connected. The home appliance 10 or the user device 200 may be connected to the electronic apparatus 100 via the wide area network (WAN).

The access point (AP) may perform communication with the home appliance 10 or the user device 200 using wireless communication such as Wi-Fi (Wi-Fi™, IEEE 802.11), Bluetooth (Bluetooth™, IEEE 802.15.1), or Zigbee (Zigbee, IEEE 802.15.4), and may connect to a wide area network (WAN) using wired communication, but is not limited thereto.

According to various embodiments, the home appliance 10 may be directly connected to the user device 200 or the electronic apparatus 100 without going through an access point (AP).

The home appliance 10 may be connected to the user device 200 or the electronic apparatus 100 via a long-range wireless network or a short-range wireless network. For example, the home appliance 10 may be connected to the user device 200 via a short-range wireless network (e.g., Wi-Fi Direct).

As another example, the home appliance 10 may be connected to the user device 200 or the electronic apparatus 100 through a wide area network (WAN) using a long-range wireless network (e.g., a cellular communication module).

As another example, the home appliance 10 may connect to a wide area network (WAN) using wired communication, and be connected to the user device 200 or the electronic apparatus 100 through the wide area network WAN.

When the home appliance 10 is capable of connecting to a wide area network (WAN) using wired communication, the home appliance 10 may also operate as a connection relay. Accordingly, the home appliance 10 may connect another home appliance to the wide area network (WAN) to which the electronic apparatus 100 is connected. In addition, another home appliance may connect the home appliance 10 to the wide area network (WAN) to which the electronic apparatus 100 is connected.

The home appliance 10 may transmit information about its operation or status to another home appliance, the user device 200, or the electronic apparatus 100 through a network. For example, when a request is received from the electronic apparatus 100, the home appliance 10 may transmit information about its operation or status to another home appliance, the user device 200, or the electronic apparatus 100 if a specific event has occurred in the home appliance 10, or periodically or in real time. Here, the status information may be sound source data obtained by measuring a noise generated by the home appliance 10.

When information about operation or status is received from the home appliance 10, the electronic apparatus 100 may update the stored information about the operation or status of the home appliance 10, and transmit the updated information about the operation and status of the home appliance 10 to the user device 200 via a network. Here, the update of information may include various operations in which existing information is changed, such as an operation of adding new information to existing information and an operation of replacing existing information with new information.

For example, the electronic apparatus 100 may collect various information to be used for training a learning model from the home appliance 10, and may perform training or retraining of the learning model using the collected information. In addition, the electronic apparatus 100 may provide the trained model to each home appliance 10.

The home appliance 10 may obtain various information from another home appliance, the user devices 200, or the electronic apparatuses 100, and may provide the obtained information to the user. For example, the home appliance 10 may obtain information related to the function of the home appliance 10 (e.g., recipes, laundry methods, etc.) or various environmental information (e.g., weather, temperature, humidity, etc.) from the electronic apparatus 100, and may output the obtained information through a user interface.

The home appliance 10 may operate according to a control command received from another home appliance, the user device 200, or the electronic apparatus 100. For example, when the home appliance 10 obtains prior approval from the user so that it can operate according to a control command of the electronic apparatus 100 even without a user input, the home appliance 10 may operate according to a control command received from the electronic apparatus 100.

Here, the control command received from the electronic apparatus 100 may include, but is not limited to, a control command input by the user through the user device 200 or a control command based on preset conditions.

The home appliance 10, the user device 200, or the electronic apparatus 100 may determine a control command using technology such as artificial intelligence. For example, the electronic apparatus 100 may receive information about the operation or status of the home appliance 10 or receive information about the user of the user device 200, process the information using technology such as artificial intelligence, and transmit the processing result or control command to the home appliance 10 or the user device 200 based on the processing result.

In one or more examples, when an error occurs in the home appliance 10, the home appliance 10 or the user device 200 may provide information about the error that occurred in the home appliance to the electronic apparatus 100. For example, the user may directly report the error that occurred in the home appliance 10 or provide it to the electronic apparatus 100 using the user device 200.

Such an error may not only be a functional failure of the home appliance 10, but also include issues such as noise generation. In one or more examples, one or more devices configured to measure or detect noise generated by a home appliance may be included in a user's home. In one or more examples, a user device (e.g., smartphone) may be configured to measure or detect noise generated by a home appliance.

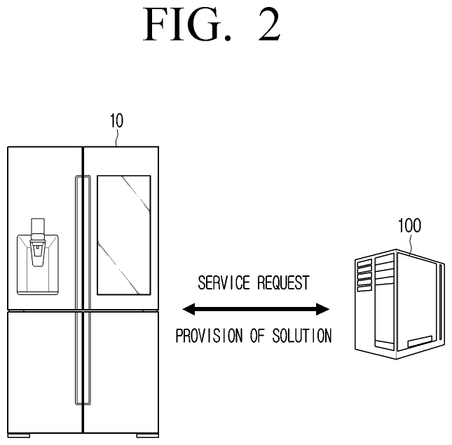

When an error of this kind is received from the home appliance 10 or the user device 200, the electronic apparatus 100 may transmit response information to the home appliance 10 or the user device 200. Such an operation will be described in detail with reference to FIG. 2. Here, the response information may be a processing history of a service requested by a user, or information for repairing an error that has occurred.

Meanwhile, in the illustrated example, the electronic apparatus 100 performs not only a remote control operation for the home appliance 10 based on a user account, but also service management, etc.. In one or more examples, remote control and service management may be performed on separate devices.

FIG. 2 is a view provided to explain a method of providing a customized service according to an embodiment.

Referring to FIG. 2, the home appliance 10 is illustrated. Such a home appliance 10 may be a refrigerator as in the illustrated example. As understood by one of ordinary skill in the art, the refrigerator is only example, and the embodiments may include other types of appliances including non-home appliances.

Such a refrigerator may experience functional failures or errors in which the refrigeration or freezing functions are not performed. A prompt service may be requested for such functional failures. However, a service request may also be made for issues such as noise generation, even if they are not functional failures. In one or more examples, a functional failure may occur when an appliance fails to operate as intended (e.g., microwave fails to heat food, dishwasher fails to spray dishes, etc.)

Since noise generation is not a functional failure, it can be treated as a lower priority than the above-described functional failure. However, if it is based on a motor error, etc., if the same issue occurs repeatedly, or if it occurs at the time of initial installation, the issue itself can be serious and can be very worrisome to the user.

As such, various errors and repair issues may occur in the home appliance 10, and the manufacturer must provide services to resolve these issues.

However, users may show various reactions to the provision of such services. Also, reactions to the same issues may vary depending on user tendencies.

For example, for a user who has repeatedly experienced the same issue, a user who has purchased the product only a few days ago, or a user who is very negative about the corresponding issue, a cautious response may be implemented. Furthermore, issues may be anticipated for users based on a previous user's history. For example, if a first user uses an appliance in accordance with a particular set of conditions that cause an error, a service request may be anticipated or pre-scheduled for another user that uses the same appliance in accordance with the particular set of conditions.

Therefore, in the present disclosure, various service histories are stored, a case most similar to the corresponding service request is searched, and a service is provided using a case among the retrieved ones that received a positive user response.

Here, the search for similar cases can be performed based on: i) similarity of the problem that occurred, ii) similarity of the user's response, iii) necessity of emergency handling, etc. In the above description, it is assumed that all three factors are analyzed, but in implementation, only some of the above-described factors may be used. In addition, factors other than those described above may also be considered.

To this end, the electronic apparatus 100 stores various service histories, applies filtering to classify user tendencies and/or failure types to identify similar cases, and proceeds with the service by referring to the resolution method or response method of the history with high customer satisfaction among the filtering results described above.

Accordingly, the electronic apparatus may provide a response or a customized service to the user in a manner with high customer satisfaction for similar issues, thereby improving service satisfaction. Alternatively, the electronic apparatus may minimize unpleasant experiences related to the user's service request.

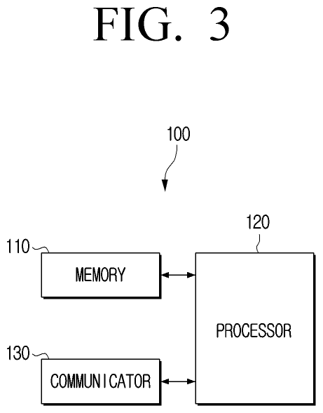

FIG. 3 is a view provided to explain configuration of an electronic apparatus according to an embodiment.

Referring to FIG. 3, the electronic apparatus 100 includes memory 110, a processor 120, and a communicator 130.

The memory 110 may be implemented as an internal memory such as ROM (e.g., electrically erasable programmable read-only memory (EEPROM)) and RAM included in the processor 120, or may be implemented as separate memory. In this case, the memory 110 may be implemented as memory embedded in the electronic apparatus 100 or as memory detachable from the electronic apparatus 100 depending on the data storage purpose. For example, in the case of data for driving the electronic apparatus 100, the data may be stored in the memory embedded in the electronic apparatus 100, and in the case of data for the expansion function of the electronic apparatus 100, the data may be stored in memory detachable from the electronic apparatus 100.

The memory 110 stores service history information. Here, the service history information stores request details for each service processing requested from each home appliance 10 or the user, user tendency information for the corresponding request, the content of the service provided for the corresponding request, and user evaluation for the provided service. In other words, the service history information may include tendency information, guide information, and evaluation information for each processing case. Meanwhile, the above-described request details may be referred to as a service field for a specific home appliance. For example, they may be used for classification of services such as noise from a washing machine, or washing machine door malfunction, and may be referred to as service field, service item, failure field, error field, etc. In one or more examples, if user accounts are associated or linked with each other (e.g., friends or neighbors may indicate an association with each other), the history information of each of the associated accounts may be grouped together.

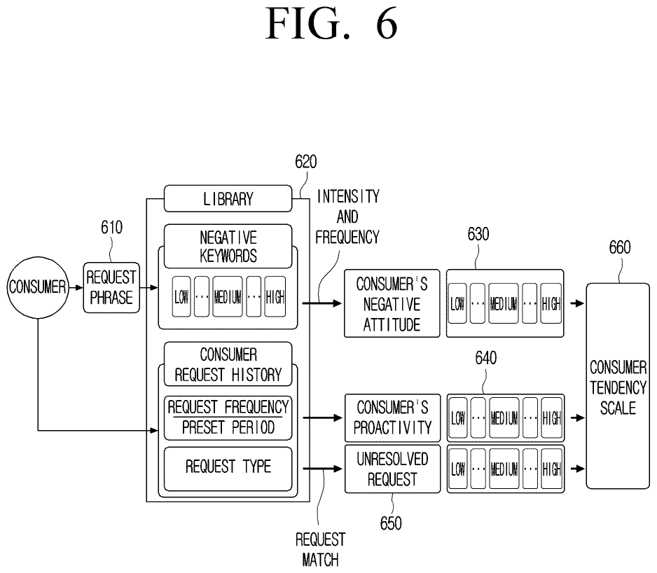

In one or more examples, tendency information may be information indicating the user's reaction to the content of the corresponding service, and three items such as negative tendency, repetition tendency, and unresolved status may be used. Meanwhile, in implementation, the user tendency may be used only for some of the three items described above, or items other than the three described above may be used. Details on each item will be described later with reference to FIG. 6.

The guide information may include the content of the service performed in response to a previously processed request. Such service content may be referred to as service details, repair method, or repair details.

The evaluation information refers to the user's evaluation of a previously provided service, and may have a grade value corresponding to one of a plurality of evaluation grades. For example, the above-described evaluation grades may be divided into two levels, or may be expressed in three or more levels, or as a score of 100 or less, or 10 or less.

Meanwhile, the memory embedded in the electronic apparatus 100 may be implemented as at least one of a volatile memory (e.g. a dynamic RAM (DRAM), a static RAM (SRAM), or a synchronous dynamic RAM (SDRAM)) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)), and the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

The communicator 130 (e.g., communication circuitry) is configured to perform communication with various types of external devices according to various types of communication methods. The communicator 130 may include a Wi-Fi module, a Bluetooth module, an infrared communication module, a wireless communication module, etc. Here, each communication module may include at least one hardware chip or hardware circuit.

The Wi-Fi module and the Bluetooth module may perform communication using a Wi-Fi method and a Bluetooth method, respectively. When using a Wi-Fi module or a Bluetooth module, various connection information such as SSID and session keys are first transmitted and received, and various information can be transmitted and received after establishing a communication connection using the same.

The infrared communication module performs communication according to an infrared Data Association (IrDA) communication technology which transmits data wirelessly over a short distance using infrared rays between optical light and millimeter waves.

The wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G), etc. in addition to the above-described communication methods.

In addition, the communicator 130 may include at least one of the wired communication modules that perform communication using a local area network (LAN) module, an Ethernet module, pair cables, coaxial cables, fiber optic cables, or a Ultra Wide-Band (UWB) module, etc.

According to an embodiment, the communicator 130 may use the same communication module (e.g., a Wi-Fi module) to perform communication with an external device such as a remote control and an external server.

The communicator 130 may receive service request information from an external device, and transmit corresponding response information to the external device. Here, the service request information is a request for repair of an error or noise, etc. that has occurred in the home appliance, and the request information may include not only the user's text information about the error or noise, but also recording data that records the noise that has occurred in the home appliance.

Although it has been described that response information is transmitted to a device that has received service request information, in implementation, the response information may be transmitted to a device other than the device that transmitted the service request information. For example, service request information may be received from a user device, and the response information may be transmitted to a home appliance. In one or more examples, in implementation, the response information may be transmitted to both the home appliance and the user device. Here, the response information may include address information where a video for resolving a specific failure, etc. is stored, may include the video content described above, or may include schedule information such as a service visit schedule. In addition, a program or setting value for direct failure diagnosis may be included.

The processor 120 may perform overall control operations of the electronic apparatus 100. Specifically, the processor 120 performs the function of controlling the overall operations of the electronic apparatus 100.

The processor 120 may be implemented as a digital signal processor (DSP) for processing digital signals, a microprocessor or a Time Controller (TCON). However, the processor 120 is not limited thereto, and may include one or more of a central processing unit (CPU), a Micro Controller Unit (MCU), a micro processing unit (MPU), a controller, an application processor (AP), a graphics-processing unit (GPU) or a communication processor (CP), and an advanced RISC machine (ARM) processor, or may be defined by the corresponding term. Further, the processor 120 may be implemented in a system-on-chip (SoC) or a large scale integration (LSI) in which a processing algorithm is embedded, or may be implemented in the form of a field programmable gate array (FPGA). In addition, the processor 120 may perform various functions by executing computer executable instructions stored in the memory. Meanwhile, although FIG. 2 illustrates that only one processor is included in the electronic apparatus 100, in implementation, a plurality of processors (e.g., CPU+GPU, CPU+DSP) may be included.

First, when receiving service request information from an external device, the processor 120 identifies at least one user tendency based on text in the received service request information. For example, the processor 120 may identify the user tendency by checking at least one of a negative tendency, a repetition tendency, and an unresolved tendency based on the text.

For example, the processor 120 may determine one of a plurality of negative grades based on the types and number of predefined negative keywords among keywords included in the text. For example, the processor 120 may store information about a plurality of negative keywords, and determine a negative grade based on the number of times the negative keywords described above are present in the text. Such a negative grade may be divided into two levels, such as upper/lower, or may be divided into three or more levels. In one or more examples, each level may be associated with an integer number (e.g., 0, 1, 2, 3, 4, etc.) where a higher integer indicates a higher degree of negativity.

The processor 120 may determine one of a plurality of repetition grades based on the number of repetitions of a service request received from an external device. The processor 120 may extract a service history for the corresponding user or home appliance from the pre-stored service history information and check the number of service history within a preset period.

For example, by checking whether there has been a service history from the same user within the past 3 months, where if there is no processing history within the corresponding period, a low grade may be determined, if there is at least one processing history within the corresponding period, a medium grade or higher grade may be determined, and if there is two or more processing histories within the corresponding period, a high grade or higher grade may be determined. In one or more examples, the above-described period and grade distinctions may be applied in different forms.

The processor 120 may determine one of a plurality of unresolved grades based on a service request history and text received from an external device. For example, the processor 120 may check whether there is a service history for the corresponding user and the same device, and if such a service history exists, determine a higher level.

The processor 120 searches for a processing history corresponding to a user tendency identified using pre-stored service history information. Here, the service history information may include tendency information, guide information, and evaluation information corresponding to each of a plurality of service processing cases.

For example, the processor 120 may perform a first search based on the identified user tendency and tendency information of the service history information. Specifically, the identified user tendency may have grade information (or score value) for each of a plurality of items (i.e., negative tendency, repetition tendency, and whether or not it is unresolved), and the processor 120 may perform the first search based on the grade information for the plurality of items.

Such a first search may be performed within the service history information corresponding to the information and error information of the home appliance.

The processor 120 may perform a supplemental or second search based on the evaluation information among the first search results. For example, the processor 120 may select a history with a high evaluation score among the first search results, or select a history with a high evaluation score above a certain level. Meanwhile, in implementation, instead of selecting one case, multiple cases can be selected and used.

The processor 120 generates service information based on the retrieved processing history. For example, when the service request information includes sound source information recorded from a noise generated by a home appliance, the processor 120 may control the communicator 130 to provide the generated service information and sound source information to an external device corresponding to a repair technician.

The processor 120 may control the communicator 130 to transmit expected or predicted processing schedule information corresponding to the generated service information to an external device. For example, in general, the processor 120 may generate response information notifying that the service is being processed in the order of requests. Conversely, in cases where a quick response is required (e.g., when a repetitive error occurs or when the user tendency is very negative), the processor 120 may immediately inform the user that the service technician has been informed immediately and will make contact within a few minutes, and may also transmit the incident to the service technician with a high priority.

As described above, the controlling method of an electronic apparatus according to the present disclosure may generate and use service information suitable for a user tendency and thus, can increase user satisfaction with the service.

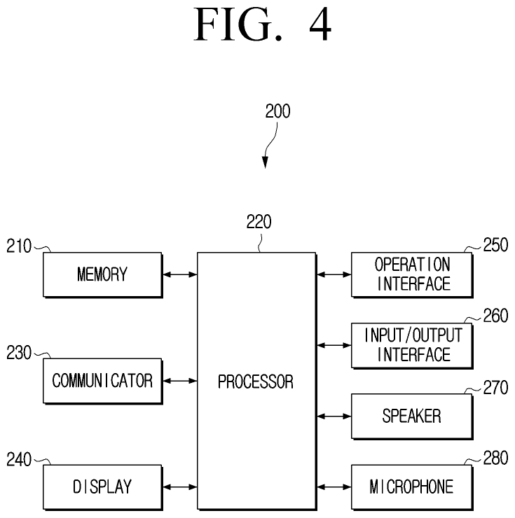

FIG. 4 is a view provided to explain configuration of a terminal device according to an embodiment.

Referring to FIG. 4, a user device 200 may include memory 210, a processor 220, a communicator 230, a display 240, an operation interface 250, an input/output interface 260, a speaker 270, and a microphone 280. Hereinafter, the user device 200 will be described assuming that it is the user device described in FIG. 1, but in implementation, the user device 200 may be the home appliance of FIG. 1.

The memory 210 may be implemented as an internal memory such as a ROM (e.g., an electrically erasable programmable read-only memory (EEPROM)) or a RAM included in the processor 220, or may be implemented as a separate memory from the processor 220. In this case, the memory 210 may be implemented as a memory embedded in the user device 200 or it may be implemented in the form of a memory removably attached to the user device 200, depending on the purpose of storing the data. For example, data for driving the user device 200 may be stored in the memory embedded in the user device 100, and data for expanding the functionality of the user device 200 may be stored in the memory removably attached to the user device 200.

The memory 210 stores instructions. The memory 210 may store sound source data or service request information generated in the process described below.

Meanwhile, the memory embedded in the user device 200 may be implemented as at least one of volatile memory (e.g., dynamic RAM (DRAM), static RAM (SRAM), or synchronous dynamic RAM (SDRAM), etc.), non-volatile memory (e.g: one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD), and the memory removably attached to the user device 200 may be implemented in the form of a memory card (e.g., compact flash (CF), secure digital (SD), micro secure digital (Micro-SD), mini secure digital (Mini-SD), extreme digital (xD), multi-media card (MMC), etc.), external memory connectable to a USB port (e.g., USB memory), etc.

Meanwhile, in the illustrated example, it is illustrated that the user device 200 consists of a single memory, but when referring to volatile memory and non-volatile memory separately, the user device 200 may be referred to as including multiple memories.

The communicator 230 is configured to perform communication with various types of external devices according to various types of communication methods. The communicator 230 may include a Wi-Fi module, a Bluetooth module, an infrared communication module, a wireless communication module, etc. Here, each communication module may be implemented as at least one hardware chip.

The Wi-Fi module and the Bluetooth module may perform communication using a Wi-Fi method and a Bluetooth method, respectively. When using a Wi-Fi module or a Bluetooth module, various connection information such as SSID and session keys are first transmitted and received, and various information can be transmitted and received after establishing a communication connection using the same.

The infrared communication module performs communication according to an infrared Data Association (IrDA) communication technology which transmits data wirelessly over a short distance using infrared rays between optical light and millimeter waves.

In addition to the above-described communication methods, the wireless communication module may include at least one communication chip that performs communication according to various wireless communication standards, such as Zigbee, 3rd Generation (3G), 3rd Generation Partnership Project (3GPP), Long Term Evolution (LTE), LTE Advanced (LTE-A), 4th Generation (4G), 5th Generation (5G), etc.

Further, the communicator 230 may include at least one of wired communication modules that perform communication using a local area network (LAN) module, an Ethernet module, pair cables, coaxial cables, fiber optic cables, or a Ultra Wide-Band (UWB) module.

For example, the communicator 230 may use the same communication module (e.g., a Wi-Fi module) to perform communication with an external device such as a remote controller and an external server.

The communicator 230 may transmit the generated service request information to an external device, and receive response information corresponding to the above-described request information.

In addition, the communicator 230 may receive information (e.g., sound source information, device information) generated by the home appliance 10. The communicator 230 may transmit a control command for controlling the home appliance 10 to the home appliance 10.

The display 240 may be implemented as various types of displays such as a Liquid Crystal Display (LCD), an Organic Light Emitting Diodes (OLED) display, a Plasma Display Panel (PDP), and the like. The display 240 may also include a driving circuit, a backlight unit, and the like, which may be implemented in the form of amorphous silicon thin film transistor (a-si TFTs), low temperature poly silicon (LTPS) TFTs, organic TFTs (OTFTs), and the like. Meanwhile, the display 240 may be implemented as a touch screen combined with a touch sensor, a flexible display, a three-dimensional (3D) display, and the like.

The display 240 may display text or images included in response information. For example, when the response information includes a video address for resolving a specific error, the display 240 may display an image corresponding to the video.

The input/output interface 260 may be one of High Definition Multimedia Interface (HDM), Mobile High-Definition Link (MHL), Universal Serial Bus (USB), Display Port (DP), Thunderbolt, Video Graphics Array (VGA) port, RGB port, D-subminiature (D-SUB), or Digital Visual Interface (DVI).

The input/output interface 260 may input/output at least one of audio or video signals. Depending on an implementation example, the input/output interface 260 may include a port that inputs/outputs only audio signals and a port that inputs/outputs only video signals as separate ports, or may be implemented as a single port that inputs/outputs both audio and video signals.

The input/output interface 260 may provide a video signal corresponding to a screen generated by the user device 200 or an audio signal together with the video signal to an external device (e.g., a display device, STB, etc.).

The speaker 270 may output sound. Specifically, the speaker 270 may be configured to output various audio data processed in the input/output interface as well as various notification sounds or voice messages. In addition, the speaker 270 may also output text included in response information.

The microphone 280 may receive various sounds and generate sound source data. For example, when a measurement application is executed, the microphone 280 may measure surrounding sounds and generate sound source data.

The processor 220 may perform overall control operations of the user device 200. Specifically, the processor 220 performs the function of controlling overall operations of the user device 200.

The processor 220 may be implemented as a digital signal processor (DSP) for processing digital signals, a microprocessor, or a Time Controller (TCON). However, the processor 220 is not limited thereto, and may include one or more of a central processing unit (CPU), a Micro Controller Unit (MCU), a micro processing unit (MPU), a controller, an application processor (AP), a graphics-processing unit (GPU) or a communication processor (CP), and an advanced RISC machine (ARM) processor, or may be defined by the corresponding term.

Further, the processor 220 may be implemented as a system-on-chip (SoC) or a large scale integration (LSI) in which a processing algorithm is embedded, or may be implemented in the form of a field programmable gate array (FPGA). In addition, the processor 220 may perform various functions by executing computer executable instructions stored in the memory. Meanwhile, although FIG. 2 illustrates that only one processor is included in the user device 200, in implementation, a plurality of processors (e.g., CPU+GPU, CPU+DSP) may be included.

The processor 220 may initiate a diagnosis according to a user request. For example, when a user voice or a user executes a diagnosis application, the processor 220 may activate a microphone for error or noise measurement of a specific home appliance. Meanwhile, the noise measurement described above may also be performed in the home appliance in implementation, so the processor 220 may control the communicator 230 to transmit control information for activating the microphone of the home appliance.

When such a corresponding application is executed as described above, the processor 220 may control the communicator 230 to transmit a control command for the corresponding home appliance to perform a specific function to the home appliance. For example, when the home appliance is a washing machine, the corresponding function may be a washing process.

When the home appliance performs a washing process through such an operation, the processor 220 may store the sound source obtained through the microphone in the memory 210.

In this case, the processor 220 may record all sounds for the entire section, or may record only a sound at the moment when the sound exceeding a certain decibel level occurs. Alternatively, the processor 220 may measure the entire section and generate noise data by editing only the part corresponding to the section where a noise occurs.

When such a diagnosis is performed, the processor 220 may control the communicator 230 to transmit the sound source information and the information of the home appliance obtained in the above-described process to the electronic apparatus 100. Meanwhile, although the above description illustrates and explains that the aforementioned operations are performed by executing a diagnostic application, in implementation, operations such as noise measurement may also be carried out during the general operation of the home appliance.

The processor 220 may receive response information corresponding to the service request information described above, that is, customized service information. When such service information is received, the processor 220 may control the display 240 or the speaker 270 to output the corresponding information.

For example, when guide content (or an address of the corresponding content) that can solve a specific problem is obtained as response information, the processor 220 may control the display 240 to display an image corresponding to the content.

Meanwhile, when the response information includes setting value information or data to be provided to the home appliance, the processor 220 may control the communicator 230 to transmit the information included in the response information to the home appliance 10.

For example, active noise canceling may be applied as a guide for solving the noise problem of the home appliance 100. In this case, the processor 220 may control the communicator 230 to transmit noise canceling information included in the obtained service information to the home appliance 10. In addition, the home appliance 10 may operate while outputting an opposite sound source corresponding to the noise included in the corresponding information through a speaker during operation. In one or more examples, the processor 220 may perform one or more filtering processes to remove background noise such that only noise from one or more home appliances remains.

Meanwhile, in the illustrated example, the sound source to be used for noise canceling is illustrated and described as being obtained by the terminal device and provided to the home appliance, but in implementation, it can be obtained directly from the home appliance. In addition, in implementation, only the setting value information to be used for active noise canceling may be transmitted and received, rather than the sound source corresponding to the noise.

As described above, the controlling method of a terminal device according to the present disclosure may generate and use service information suitable for a user tendency, thereby increasing user satisfaction with the service.

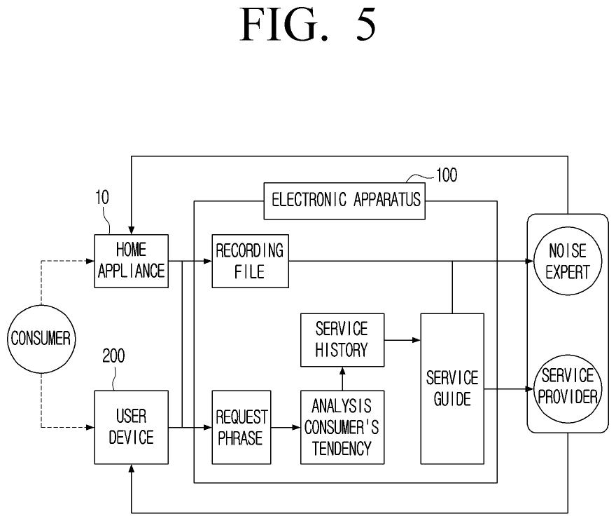

FIG. 5 is a view provided to explain a service processing operation according to an embodiment.

Referring to FIG. 5, the service processing operation may be performed in the home appliance 10, the user device 200 and the electronic apparatus 100.

First, when the user determines that noise is generated from the home appliance 10 and diagnosis or sound measurement is necessary, the user may measure the noise using the microphone of the home appliance 10 or the microphone of the user device 200.

The user device 200 may transmit text recording the measured noise and symptoms associated with the noise to the electronic apparatus 100. In other words, the user device 200 may transmit a service request for repair of the noise to the electronic apparatus 100.

The electronic apparatus 100 that receives such the service request may analyze cases similar to the request. Specifically, among multiple service cases, cases similar to a failure (or problem) of the corresponding home appliance may be filtered out, and among those cases, cases similar to the current user tendency can be identified. For example, the electronic apparatus 100 may analyze the level of consumer dissatisfaction and/or severity based on the text.

The electronic apparatus 100 may obtain a service guide corresponding to the service request based on the analysis and the previously stored service history. For example, the electronic apparatus 100 may check the case with the most similar tendency to the consumer's tendency among the previously stored service history and select the service content that elicited the most positive response as a guide.

The electronic apparatus 100 may transmit the corresponding service guide and noise file to a noise expert (i.e., an AS technician). The service guide may be transmitted to the user device 200 corresponding to the user.

As such, by proceeding with the service is provided based on the service that elicited the most positive response among the existing history, it is possible to provide a service more suitable for the user.

Meanwhile, in FIG. 5, it is assumed that a recording file is used for explanation, but in implementation, a video file or a photo may be used instead of a recording file. In addition, only information such as text may be provided to the electronic apparatus 100 without separate content creation.

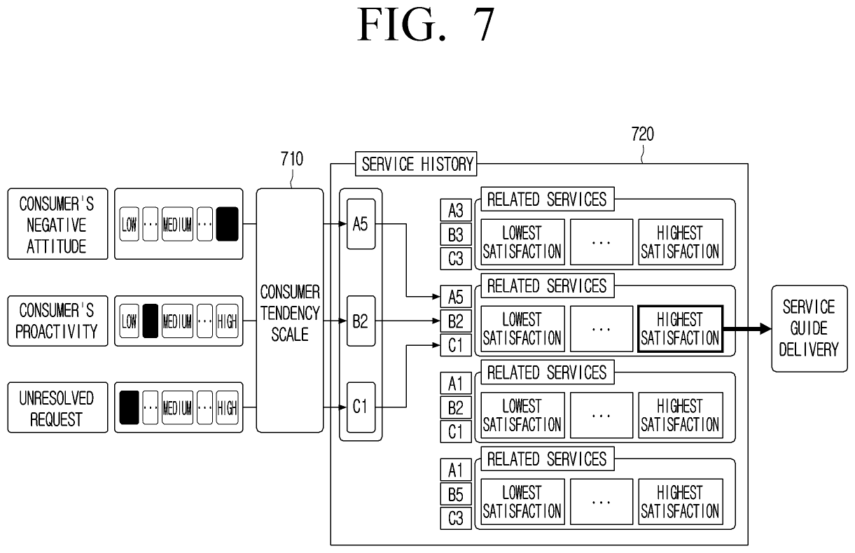

A more specific method of analyzing consumer tendencies and the operation of selecting a service guide based on the analyzed tendencies will be described in greater detail with reference to FIGS. 6 and 7.

FIG. 6 is a view provided to explain an operation of obtaining a user tendency according to an embodiment.

Referring to FIG. 6, the electronic apparatus 100 may analyze received text (610).

The electronic apparatus 100 may identify a user tendency using the text and a pre-stored library (620). Here, the user tendency may be divided into negative attitudes, level of consumer proactivity, and the presence of unresolved requests. In the illustrated example, three items are illustrated, but only some of the items may be used or other items not illustrated may be additionally used in implementation.

In one or more examples, the negative attitude may be a process of checking whether keywords registered in the library are included in the text. For example, the consumer's negative attitude may be determined by comparing the request phrase sent by the consumer to the server with a list of negative keywords stored in the library of the server, extracting the same or similar keywords, and determining the level of negative attitude according to the frequency and intensity of the keywords. The negative keywords stored in the library may be classified by intensity based on the severity of negativity (630).

The level of consumer's proactivity may be classified by extracting cases matching the consumer's information from the consumer request history and calculating the frequency of service requests made over a certain period of time (640).

When the request history is compared with the request phrase and the same type of request is identified, it is determined that the request is unresolved as the frequency increases, and the unresolved status can be classified according to the degree (650).

FIG. 7 is a view provided to explain an operation of searching a processing history according to an embodiment.

Referring to FIG. 7, a user tendency may be identified through the process described above (710). By checking a grade value (or score) for each of a plurality of items through such identification, cases similar to each grade value (or score) can be identified in the service history.

For example, each type of consumer tendency scales may be represented by symbols such as letters A, B, C, and the intensity of each item may be expressed in numbers and graded. Then, clusters of service contents with similar or identical scales to the graded consumer scale may be searched.

Subsequently, based on the service contents with the highest satisfaction among the clusters, the service guide can be delivered to the service provider and noise expert. In this case, if the level of unresolved requests is high, the noise expert can take measures such as checking more specifically or cross-checking with other experts, and the service provider can check the guide and provide a service optimized for each consumer's tendency and circumstances.

Accordingly, since a guide is provided based on the most optimal contents corresponding to the given situation among the vast amount of service history, it is possible to prevent mistakes that may occur due to inexperienced service providers caused by mere classification, and to minimize unpleasant experiences for the consumer.

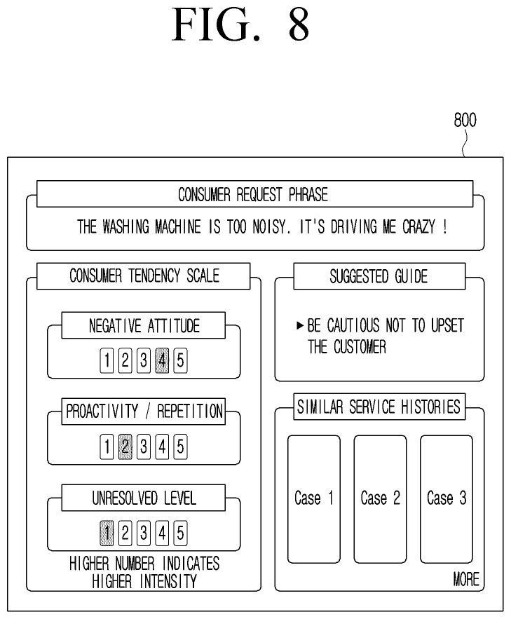

FIG. 8 is a view illustrating an example of searching a processing history according to an embodiment. Specifically, FIG. 8 is an example of a history requesting repair of noise generation in a washing machine.

Referring to FIG. 8, a user requested a service for repair of a noise problem in a washing machine.

When analyzing the text of the service request, it may be evaluated that the user has a high grade for the tendency related to a negative attitude, as the text includes negative keywords. On the other hand, since there is no previous service request history for the corresponding matter, the items on proactivity and unresolved level can be evaluated as low.

As such, when the negative attitude is evaluated as 4, the positive attitude is evaluated as 2, and the unresolved level is evaluated as 1, the electronic apparatus 100 may search for cases having item values of 4, 2, and 1 among the stored service histories. Meanwhile, in implementation, the item values may not be used as they are, but cases may be searched by expanding them to a certain range. For example, (5, 2, 1), (3, 2, 1), (4, 1, 1), (4, 3, 1), (4, 2, 2), etc. may be searched along with (4, 2, 1).

When multiple cases like this are identified, the guide can be selected by checking the cases that received high grades among the identified cases.

For example, as illustrated, cases where the user's mood must be attended to with can be selected and used.

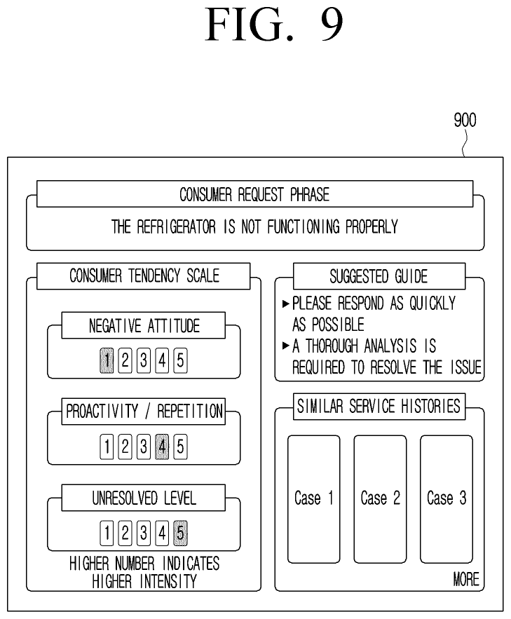

FIG. 9 is a view illustrating an example of searching a processing history according to an embodiment. Specifically, FIG. 9 is an example of a history requesting repair of noise generation in a refrigerator.

Referring to FIG. 9, a service request was made to repair a refrigerator malfunction.

When analyzing the text of the service request, it may be evaluated that the user has a low grade for the tendency related to a negative attitude, as the user did not use negative keywords when writing the text.

On the other hand, since the service issue has occurred repeatedly, the items on the proactivity and unresolved level can be evaluated as high.

As such, when the negative attitude is evaluated as 1, the positive attitude as 4, and the unresolved level as 5, the electronic apparatus 100 may search for cases having item values of 1, 4, and 5 among the stored service histories. Meanwhile, in implementation, the item values may not be used as they are, but may be expanded to a certain range to search for cases.

When multiple cases like this are identified, the guide can be selected by checking the cases that received high grades among the identified cases.

For example, a guide that is determined to require a quick response to the corresponding error may be used.

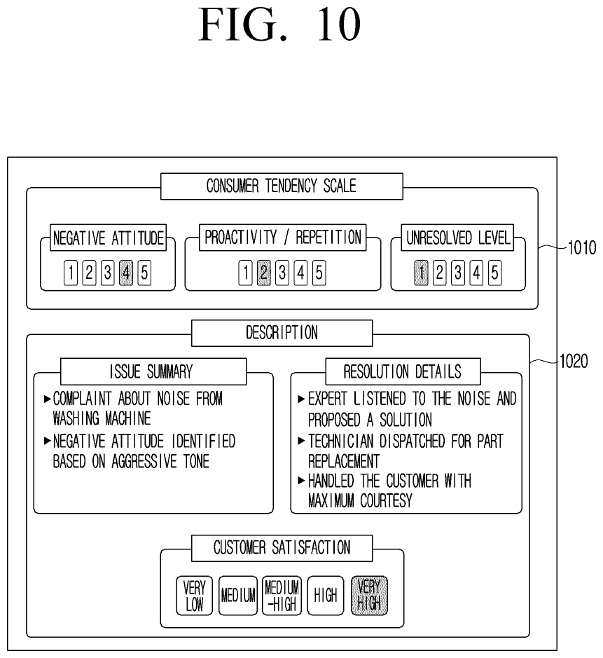

FIG. 10 is a view illustrating an example of searching a processing history according to an embodiment. Specifically, FIG. 10 is an example of a history requesting repair of noise generation in a washing machine.

Referring to FIG. 10, this is a case where a service request was made with a very negative tone regarding the noise of the washing machine.

The text of the service request may be analyzed to identify a user tendency (1010).

The electronic apparatus 100 may identify the values for each item as 4, 2, and 1. In this case, the electronic apparatus 100 may search for cases having 4, 2, and 1. Meanwhile, in implementation, the item values may not be used as they are, but may be expanded to a certain range to search for cases.

When multiple cases like this are identified, the guide can be selected by checking the cases that received high grades among the identified cases.

For example, with respect to the corresponding error, a guide requiring expert review may be used by checking expert analysis and the history of parts replacements (1020).

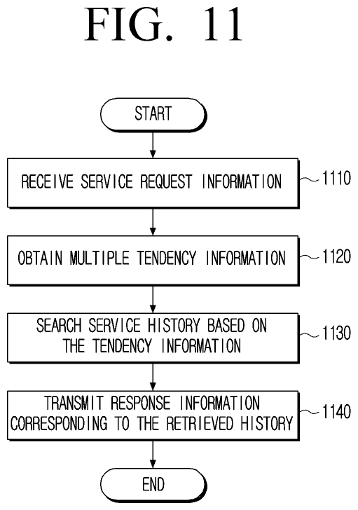

FIG. 11 is a flowchart provided to explain a controlling method of an electronic apparatus according to an embodiment.

First, service request information is received from an external device (1110). Such service request information may include user text, and optionally store a noise source. Here, the noise source may be a sound content or a video. Meanwhile, such service request information may be received through a user terminal device, and may be received directly from a home appliance in implementation.

At least one user tendency is identified based on the text in the received service request information (1120). For example, the user tendency may be identified by checking at least one of a negative tendency, a repetition tendency, or whether there is unresolved issue based on the text.

For example, one negative grade among a plurality of negative grades may be determined based on the type and number of predefined negative keywords among keywords included in the text, one repetition grade among a plurality of repetition grades may be determined based on the number of repetitions of service requests received from an external device, and one unresolved grade among a plurality of unresolved grades may be determined based on the history and text of service requests received from the external device.

Then, a processing history corresponding to the identified user tendency is searched using pre-stored service history information (1130). Here, the service history information may include tendency information, guide information, and evaluation information corresponding to each of a plurality of service processing cases.

For example, a first search may be performed based on the identified user tendency and tendency information of the service history information, and a first search may be performed based on evaluation information among the first search results. At this time, the identified user tendency may have grade information for each of a plurality of items, and the first search may be performed based on grade information for the plurality of items.

Meanwhile, the service request information may include information and error information of the home appliance. In this case, the above-described first search may perform a search within the service history information corresponding to the information and error information of the home appliance.

Then, service information is generated based on the retrieved processing history (1140). For example, when the service request information includes sound source information recorded from a noise generated by a home appliance, the generated service information and the sound source information may be provided to an external device corresponding to a repair technician. Alternatively, expected processing schedule information corresponding to the generated service information may be transmitted to the external device.

As described above, the controlling method of an electronic apparatus according to the present disclosure may generate and use service information suitable for a user tendency, thereby increasing user satisfaction with the service.

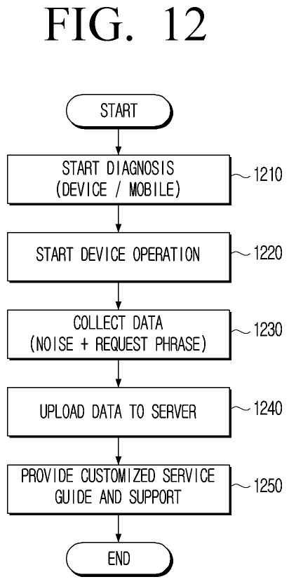

FIG. 12 is a flowchart provided to explain a controlling method of a terminal device according to an embodiment.

Referring to FIG. 12, a diagnosis may be initiated according to a user request (1210). For example, when a user voice or a user executes a diagnosis application, a function for measuring an error or a noise of a specific home appliance may be performed.

As such, when the corresponding application is executed, the terminal device may transmit a control command to the home appliance to cause the home appliance to perform a specific function (S1220). For example, when the home appliance is a washing machine, the function may be a washing process.

When the washing process is performed by the home appliance through such an operation, the terminal device may obtain the sound during the process through the microphone (1230). At this time, the terminal device may record all the sounds for the entire section, or may measure the sound at a point in time when a certain decibel level or higher is detected. Alternatively, as described above, the entire section may be measured, and the section above a certain level of sound may be edited.

Meanwhile, in implementation, the sound acquisition described above may be performed not only by the terminal device but also jointly by the corresponding home appliance, or solely by the corresponding home appliance.

When such a diagnosis is performed, the sound source information and the information of the home appliance obtained in the above-described process may be transmitted to the electronic apparatus 100 (1240).

Subsequently, response information corresponding to the service request information described above, i.e., customized service information, may be received (1250).

As described above, the controlling method of a terminal device according to the present disclosure may generate and use service information suitable for a user tendency, thereby increasing user satisfaction with the service.

Although FIG. 12 illustrates that the above-described operation is performed in a terminal device, the above-described operation may be performed in a home appliance in implementation.

Meanwhile, the methods according to various embodiments of the present disclosure described above may be implemented in the form of an application that can be installed in the existing electronic apparatuses.

In addition, the methods according to at least one of the various embodiments of the present disclosure described above may be implemented by software upgrade to the existing electronic apparatuses, or by hardware upgrade alone.

Further, the methods according to at least one of the various embodiments of the present disclosure described above may be performed through an embedded server provided in an electronic device, or at least one external server of the electronic apparatus.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus (e.g., electronic apparatus (A)) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in a form of a non-transitory storage medium. Here, the term ‘non-transitory storage media’ means that the storage medium is tangible without including a signal, and does not distinguish whether data are semi-permanently or temporarily stored in the storage medium. For example, the ‘non-transitory storage media’ may include a buffer in which data is temporarily stored. According to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine, or may be distributed online (e.g., by download or upload) directly between two user devices (e.g., terminal devices) via an application store. In case of the online distribution, at least a portion of the computer program product (e.g., downloadable app) may be at least temporarily stored in a storage medium such as a memory of a server of a manufacturer, a server of an application store, or a relay server or be temporarily generated.

The various embodiments of the present disclosure described above may be implemented as software including instructions stored in machine-readable storage media, which can be read by machine (e.g.: computer). The machine refers to a device that calls instructions stored in a storage medium, and can operate according to the called instructions, and the device may include an electronic apparatus (e.g., electronic apparatus 100) according to the aforementioned embodiments.

In case the above-described instruction is executed by a processor, the processor may perform a function corresponding to the instruction by itself, or by using other components under its control. The instruction may include a code that is generated or executed by a compiler or an interpreter.

Although preferred embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic apparatus comprising:
communication circuitry configured to perform communication with an external device;
memory storing at least one instruction and service history information; and
at least one processor operatively coupled to the memory and the communication circuitry,
wherein the at least one instruction, when executed by the at least one processor individually or collectively, cause the electronic apparatus to:
based on service request information being received from the external device, identify at least one user tendency based on the received service request information;
search a processing history corresponding to the identified at least one user tendency using the service history information; and
generate service information based on the processing history.

2. The electronic apparatus as claimed in claim 1, wherein the service history information includes tendency information, guide information, and evaluation information corresponding to each of a plurality of service processing cases; and
wherein the at least one instruction, when executed by the at least one processor individually or collectively, cause the electronic apparatus to:
perform a first search based on the identified at least one user tendency and tendency information of the service history information; and
perform a second search based on evaluation information among a result of the first search.

3. The electronic apparatus as claimed in claim 2, wherein the identified at least one user tendency has grade information for each of a plurality of items; and
wherein the at least one instruction, when executed by the at least one processor individually or collectively, further cause the electronic apparatus to further perform the first search based on the grade information for each of the plurality of items.

4. The electronic apparatus as claimed in claim 2, wherein the service request information includes information of a home appliance and error information; and
wherein the at least one instruction, when executed by the at least one processor individually or collectively, further cause the electronic apparatus to perform the first search within service history information corresponding to the information of the home appliance and the error information.

5. The electronic apparatus as claimed in claim 1, wherein the service request information includes sound source information recorded from a noise generated by a home appliance; and
wherein the at least one instruction, when executed by the at least one processor individually or collectively, further cause the electronic apparatus to control the communication circuitry to provide the generated service information and the sound source information to an external device corresponding to a repair technician.

6. The electronic apparatus as claimed in claim 1, wherein the at least one instruction, when executed by the at least one processor individually or collectively, further cause the electronic apparatus to control the communication circuitry to transmit estimated processing schedule information corresponding to the generated service information to the external device.

7. The electronic apparatus as claimed in claim 1, wherein the at least one instruction, when executed by the at least one processor individually or collectively, further cause the electronic apparatus to identify a user tendency by checking at least one of a negative tendency, a repetition tendency, an unresolved status based on text in the received service request information.

8. The electronic apparatus as claimed in claim 7, wherein the at least one instruction, when executed by the at least one processor individually or collectively, further cause the electronic apparatus to determine one negative grade among a plurality of negative grades based on a type and number of predefined negative keywords among keywords included in the text.

9. The electronic apparatus as claimed in claim 7, wherein the at least one instruction, when executed by the at least one processor individually or collectively, further cause the electronic apparatus to determine one repetition grade among a plurality of repetition grades based on a number of repetitions of a service request received from the external device.

10. The electronic apparatus as claimed in claim 7, wherein the at least one instruction, when executed by the at least one processor individually or collectively, further cause the electronic apparatus to determine one unresolved grade among a plurality of unresolved grades based on a service request history received from the external device and the text.

11. A controlling method of an electronic apparatus, the method comprising:
receiving service request information from an external device;
identifying at least one user tendency based on the received service request information;
searching a processing history corresponding to the identified at least one user tendency using pre-stored service history information; and
generating service information based on the processing history.

12. The method as claimed in claim 11, wherein the service history information includes tendency information, guide information and evaluation information corresponding to each of a plurality of service processing cases; and
wherein the searching comprises:
performing a first search based on the identified at least one user tendency and tendency information of the service history information; and
performing a second search based on evaluation information among a result of the first search.

13. The method as claimed in claim 12, wherein the identified at least one user tendency has grade information for each of a plurality of items; and
wherein the searching further comprises performing the first search based on the grade information for each of the plurality of items.

14. The method as claimed in claim 12, wherein the service request information includes information of a home appliance and error information; and
wherein the searching further comprises performing the first search within service history information corresponding to the information of the home appliance and the error information.

15. A non-transitory computer-readable recording medium having instructions stored therein, which when executed by a processor of an electronic apparatus, cause the processor execute a controlling method comprising:
receiving service request information from an external device;
identifying at least one user tendency based on the received service request information;
searching a processing history corresponding to the identified at least one user tendency using pre-stored service history information; and
generating service information based on the processing history.

16. The non-transitory computer-readable recording medium according to claim 15, wherein the service history information includes tendency information, guide information and evaluation information corresponding to each of a plurality of service processing cases; and
wherein the searching comprises:
performing a first search based on the identified at least one user tendency and tendency information of the service history information; and
performing a second search based on evaluation information among a result of the first search.

17. The non-transitory computer-readable recording medium as claimed in claim 16, wherein the identified at least one user tendency has grade information for each of a plurality of items; and
wherein the searching further comprises performing the first search based on the grade information for each of the plurality of items.

18. The non-transitory computer-readable recording medium as claimed in claim 16, wherein the service request information includes information of a home appliance and error information; and
wherein the searching further comprises performing the first search within service history information corresponding to the information of the home appliance and the error information.

19. The non-transitory computer-readable recording medium as claimed in claim 15, wherein the service request information includes sound source information recorded from a noise generated by a home appliance; and
wherein the method further comprises controlling communication circuitry of the electronic apparatus to provide the generated service information and the sound source information to an external device corresponding to a repair technician.

20. The non-transitory computer-readable recording medium as claimed in claim 15, wherein the method further comprises controlling communication circuitry of the electronic apparatus to transmit estimated processing schedule information corresponding to the generated service information to the external device.
